(19) United States
(12) Patent Application Publication
(10) Pub. No.: US 2019/0379469 A1
(43) Pub. Date: Dec. 12, 2019

(54) NETWORK SYMBOL DISPLAY IN DUAL CONNECTIVITY REGIONS

(71) Applicant: T-Mobile USA, Inc., Bellevue, WA (US)

(72) Inventors: Kun Lu, Bellevue, WA (US); Egil Gronstad, Encinitas, CA (US); Ming Shan Kwok, Seattle, WA (US); Jun Liu, Issaquah, WA (US); Alan Denis MacDonald, Bellevue, WA (US)

(21) Appl. No.: 16/120,605

(22) Filed: Sep. 4, 2018

Related U.S. Application Data
(60) Provisional application No. 62/681,286, filed on Jun. 6, 2018.

(51) Int. Cl. H04B 17/318; H04W 76/27; H04W 76/15; H04W 24/10; H04L 12/26

(52) U.S. Cl. CPC H04B 17/318; H04W 76/27; H04L 43/16; H04W 24/10; H04W 76/15

(57) ABSTRACT

A wireless communication system may support two types of networks, such as a 4^{th}-Generation (4G) network and a 5^{th}-Generation (5G) network. The 4G network is accessed through Long-Term Evolution (LTE) base stations. The 5G network is accessed through New Radio (NR) base stations. LTE base stations are configured to broadcast information regarding 5G availability. For example, an LTE base station may indicate whether it is configured to support Non-Standalone Architecture (NSA) Dual Connectivity in conjunction with an associated NR base station. When a communication device receives an indication that NSA Dual Connectivity is available, the communication device scans and measures signal strengths on each of multiple frequencies that are potentially being used by the NR base station. This can be done without decoding of the signals. If a signal having a sufficient signal strength is found, the communication device displays a 5G symbol in its status bar.

### CROSS-REFERENCE TO RELATED APPLICATION

This application claims priority to a co-pending, commonly owned U.S. Provisional Patent Application No. 62/681,286, filed on Jun. 6, 2018, and titled “5G Icon Trigger Improvement for 5G Capable UE in Idle Mode Under 5G EN-DC,” which is herein incorporated by reference in its entirety.

### BACKGROUND

Cellular communication devices use various network radio access technologies to communicate wirelessly with geographically distributed base stations. Long-Term Evolution (LTE) is an example of a widely implemented radio access technology, which is used within 4^{th}-Generation (4G) communication systems. New Radio (NR) is a newer radio access technology that is used in 5^{th}-Generation (5G) communication systems. Standards for LTE and NR radio access technologies have been developed by the 3rd-Generation Partnership Project (3GPP) for use within cellular communication networks by wireless communication carriers. Note that the terms 4G and LTE are often used interchangeably when referencing certain 4G systems and components. Also, NR radio access technology may at times be referred to as 5G radio access technology.

A configuration defined by the 3GPP in the 5G NR specification, referred to as Non-Standalone Architecture (NSA), allows the simultaneous use of 4G and 5G systems for communications with a communication device. Specifically, NSA uses Dual Connectivity (DC), in which a communication device uses both an LTE radio and an NR radio for downlink receptions from and uplink transmissions to corresponding LTE and NR base stations. An LTE carrier is used for control-plane signaling and for user-plane communications. An NR carrier is used for additional user-plane bandwidth as well as for data download or transmission throughput. In a scenario such as this, the LTE carrier is said to “anchor” the communication session.

Existing 4G networks use relatively low radio frequencies, such as frequencies in bands below 6 GHz. 5G networks are able to use an extended range of frequency bands compared to 4G networks, such as higher frequency bands in the 6-100 GHz spectrum. Frequency bands in the 6-100 GHz spectrum are generally referred as mmWave frequency bands as their wavelength is within the millimeter range. Radio communications using the higher frequency 5G bands can support higher data speeds, but also have disadvantages compared to the lower frequency bands. Specifically, radio signals in the higher frequencies have shorter range and are more easily blocked by physical objects. Accordingly, the ability for a communication device to communicate using higher-frequency 5G bands may be sporadic as the device is physically moved.

Communication devices such as smartphones often have a status bar that shows, among other things, the current signal strength and/or signal quality of the current wireless connection with a base station. In addition, the status bar may have a network indicator, such as an icon or symbol, that indicates the network type being used for the current wireless connection. For example, the network indicator might comprise a “4G LTE” symbol when the current connection is over an LTE network, and a 5G symbol when the current connection is over a 5G network.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a block diagram of a communication network that implements both 4G and 5G technologies.

FIG. 2 is a flow diagram illustrating an example method of determining which of two or more networks to indicate as being currently available for use by a mobile device or other communication device.

FIG. 3 is a block diagram of an example mobile communication device that may be configured in accordance with the described techniques.

### DETAILED DESCRIPTION

Described herein are techniques for determining which of multiple network identifiers to display on the status bar of a wireless communication device, when the device is operating in a cellular network of a wireless communications provider that has areas of dual signal coverage. Network identifiers might include, for example, symbols that indicate 3G, 4G, LTE, 5G, and so forth, corresponding to different wireless network standards.

The described techniques may be useful when a wireless communication device is within an area that is supported by both 4G and 5G technologies, for example. In this situation, 5G signals may be intermittent because of their higher frequencies.

When using 5G Non-Standalone Architecture (NSA), an initial connection between the device and an LTE base station is configured based on LTE system information. System information in the LTE environment is broadcast by the LTE base station in data objects referred to as System Information Blocks (SIBs). System information may include information relating to cell access, scheduling, communication channels and frequencies, network identifiers, tracking area codes (TACs), cell IDs, status, power levels, paging information, neighboring cells, etc.

Cellular communication devices receive the LTE system information prior to establishing connections with LTE base stations, as well as during the connections. When there are changes in the system information of an LTE base station, connected cellular communication devices are notified and the changes are retrieved from subsequently broadcast SIBs.

In a cell that supports NSA, and that therefore has both LTE and NR base stations, the LTE base station is configured to broadcast information indicating that the cell supports NSA Dual Connectivity. This information may be included in an LTE SIB. In accordance with 3GPP TS 36.331 Release 15, this information is conveyed by a single-bit value called “upperLayerIndication” within what is known as SIB2. This value may be referred to at times herein as a 5G availability indicator.

A wireless communication device, often referred to in this environment as a User Equipment (UE) or Mobile Station (MS), monitors the broadcast channels of one or more nearby LTE base stations in order to receive LTE SIBs. When in a cell that supports NSA, the upperLayerIndication value may indicate NSA support, but may nevertheless be in a location where NR signals of the cell are too weak to be used. This may be particularly problematic when the device is in idle mode, because when in idle mode the device does not maintain an active 5G communication channel. Under NSA, 5G communication channels are instead set up when the device is in a connected state. Accordingly, before displaying a 5G symbol indicating that 5G services are available, the device is configured to take further steps to confirm that 5G services are indeed available.

When the device receives an SIB indication that the current LTE base station and network cell support NSA, the device scans one or more 5G frequencies to search for a 5G broadcast signal, and measures the signal strength of any broadcast signals that it finds in these frequencies. The device is configured to do this without decoding the data conveyed by the broadcast signal, thereby saving computational resources that might otherwise be used.

In some implementations, the device may be configured to receive NR configuration information during initial attachment to the LTE base station. Specifically, the LTE base station may use RRC signaling with the device to specify the frequencies that are potentially used for NR broadcast transmissions by the NR base station associated with the LTE base station. Based on this information, the device can limit the search of NR frequencies to those that are actually in use, and avoid other frequencies that are not used by the communications provider in the area where the device is located.

In other implementations, the device may be preconfigured with stored information indicating the possible frequencies of NR transmissions by either the communications provider or by NR base stations in specific locations.

The device is configured to compare the measured NR signal strength to a signal strength threshold, where the signal strength threshold is equal to the approximate minimum signal strength that would be needed to support NR data communications. If the measured signal strength is greater than the threshold, the device displays a 5G symbol to inform the user of the device that the device is currently able to use 5G services. Otherwise, the device displays the 4G or LTE symbol.

Although the techniques are described in the context of 4G and 5G networks, the techniques described herein may also be used with different network types, standards, and technologies. That is, the techniques may be used more generally for first and second wireless communication networks, where a 4G network is an example of the first wireless communication network and a 5G network is an example of the second wireless communication network.

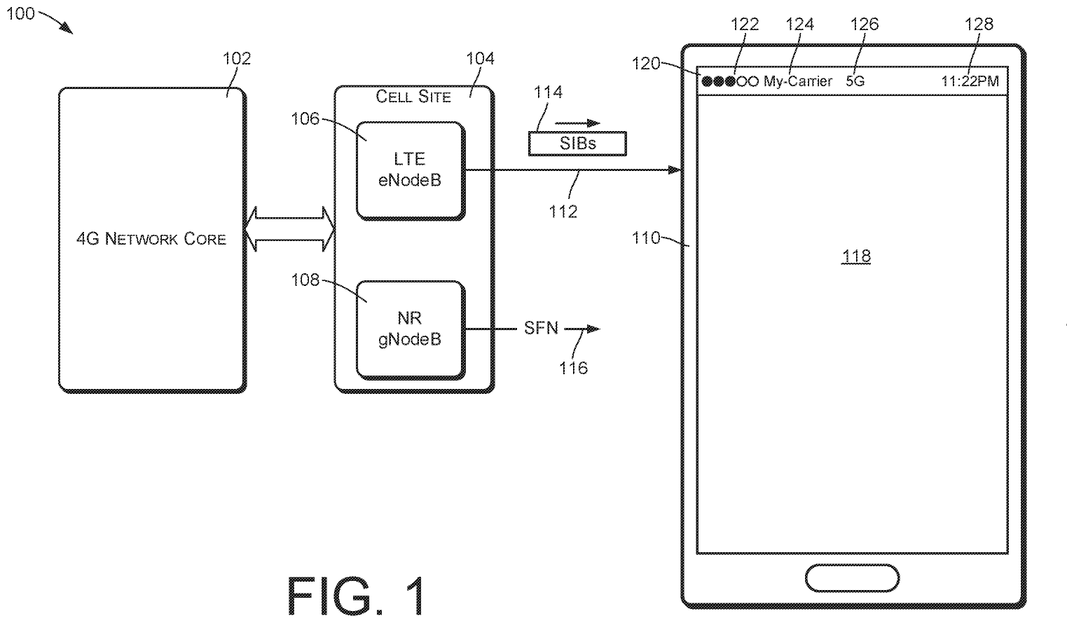

FIG. 1 illustrates relevant high-level components of a cellular communication system 100, such as might be implemented by a cellular communications provider. The communication system 100 has a 4G network core 102. The communication system 100 also has multiple cell sites 104, only one of which is shown in FIG. 1 for purposes of discussion. Although not shown, some networks may include a 5G network core.

The illustrated cell site 104 supports both 4G and 5G communications, and therefore has both 4G and 5G cellular access points. The 4G access point is implemented as an LTE base station 106, also referred to as an eNodeB, a master eNodeB, or a master base station. The 5G access point is implemented as an NR base station 108, also referred to as a gNodeB, a secondary gNodeB, or a secondary base station. The 4G network core 102 communicates with the LTE base station 106 and the NR base station 108. Radio communications are controlled by the LTE master base station. Other communication paths may be used in other embodiments. Note that some cell sites of the system 100 might lack 5G support, and may support only 4G services and communications.

FIG. 1 shows a single cellular communication device 110, which may be one of many such devices that are configured for use with the communication system 100. In the described embodiment, the communication device 110 supports both 4G/LTE and 5G/NR networks and communications. Accordingly, the communication device 110 has an LTE radio (not shown) that communicates wirelessly with the LTE base station 106 of the cell site 104 and an NR radio (not shown) that communicates wirelessly with the NR base station 108 of the cell site 104.

The communication device 110 may comprise any of various types of wireless cellular communication devices that are capable of wireless data and/or voice communications, including smartphones and other mobile devices, “Internet-of-Things” (IoT) devices, smarthome devices, computers, wearable devices, entertainment devices, industrial control equipment, etc. In some environments, the communication device 110 may be referred to as a User Equipment (UE) or Mobile Station (MS).

The communication device 110 may communicate through either or both of the LTE base station 106 and the NR base station 108. In some cases or embodiments, the communication device 110 may support Dual Connectivity communications, in which a single communication session might simultaneously use both a 4G connection and a 5G connection. More specifically, the communication device 110 may operate using what is referred to as a Non-Standalone Architecture (NSA), using 5G radio technologies to augment 4G communication capabilities. When using NSA, the communication device 110 uses both an LTE carrier and an NR carrier for downlink data reception and uplink transmissions.

When the communication device 110 is in idle mode, it receives an LTE Radio Resource Control (RRC) signal 112 from the LTE base station 106. The RRC signal 112 may be broadcast for reception by multiple communication devices, and may contain information regarding capabilities and characteristics of the LTE base station 106. For example, RRC messaging may include information needed by a communication device to establish bi-directional communications with the LTE base station 106. In the LTE environment, at least some of this information is provided in a periodically broadcast master information block (MIB) and multiple system information blocks (SIBs). FIG. 1 shows a single SIB 114 that is being broadcast by the LTE base station 106. The SIB 114 can be received by multiple communication devices, including the illustrated communication device 110.

The communication device 110 does not necessarily maintain a connection with the NR base station 108 when the device 110 is operating in idle mode. Furthermore, the NR base station 108 may not transmit SIBs or other RRC signaling. However, 3GPP specifications indicate that the NR base station 108 is to transmit System Frame Numbers (SFNs) that are used for timing of communications. FIG. 1 shows an RF SFN signal 116 transmitted by the NR base station 108. The RF SFN signal 116 is used to convey SFN information.

In certain embodiments, the device 110 does not monitor or decode the NR SFN information when the device 110 is in idle mode. Although the RF SFN signal 116 may be broadcast and available to the communication device 110, when in idle mode the communication device 110 does not demodulate or decode the RF SFN signal 116 to obtain the SFNs.

The communication device 110 has a display 118 for presenting information and for interacting with a user. A status bar 120 is typically shown at the top of the display 118. In this example, the status bar 120 has a signal strength meter 122, a carrier identifier 124, and a network identifier 126. The status bar 120 also indicates the current time of day in a time field 128.

The signal strength meter 122 shows the strength and/or quality of signals or communication channels that have been established with the LTE base station 106 and/or the NR base station 108. The carrier identifier 124 corresponds to the network carrier or provider whose signals are being used for communications.

The network identifier 126 indicates the type of network that is being used by the communication device 110. More specifically, the displayed network identifier 126 corresponds to and identifies the wireless communication standard that is currently being used for communications by the communication device. In the example described herein, the network identifier 126 indicates LTE when operating in a 4G LTE environment, and 5G when operating in a 5G NR environment. Other embodiments may of course have different types of networks, corresponding to different communication protocols, and may use symbols corresponding to those communication protocols.

It is generally intended for the status bar 120 to show a network identifier 126 corresponding to the most advanced or highest-capability cellular network that is available for use by the communication device 110. In the system described herein, a 5G symbol is displayed whenever the communication device 110 is in a location where 5G communications are available.

In certain implementations, a network availability indicator is included in one of the SIBs 114 that is broadcast periodically by the LTE base station 106. The network availability indicator indicates whether the LTE base station 106 is in a geographic area within which 5G services are available. More specifically, the LTE base station includes the network availability indicator when the LTE base station is associated with a 5G base station and configured to support NSA Dual Connectivity in conjunction with the 5G base station.

In some embodiments, the network identifier 126 may comprise a variable in the SIB, where the variable has a positive value when 5G services are available, and a negative value when 5G services are not available. In some embodiments, this variable comprises an “upperLayerIndication” value that is contained in SIB2, in accordance with 3GPP TS 36.331 Release 15.

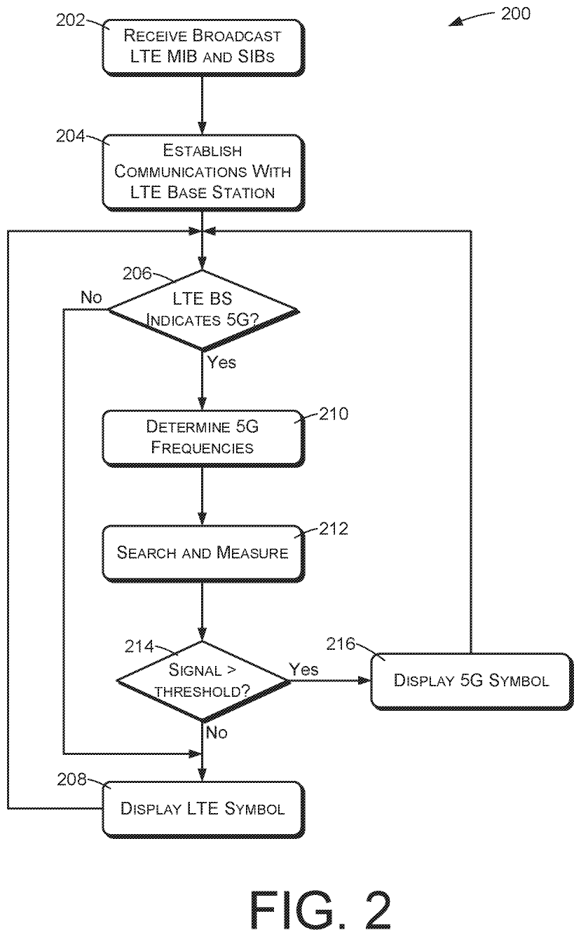

FIG. 2 illustrates an example method 200 that may be performed by a cellular communication device, such as a cellular telephone or smartphone, to determine which of multiple network symbols should be displayed in the status bar of the communication device. The example method 200 may be performed in an environment in which a first wireless communication network, such as a 4G network, serves multiple geographic areas, while a second wireless communication network, such as a 5G network, serves only some of the multiple geographic areas. The cellular communication device communicates through a first, master base station, to access the 4G cellular communication network. The communication device communicates through a second, secondary base station, to access the 5G cellular communication network.

The first, master base station is implemented in accordance with a first wireless communication standard, such as LTE, and is referred to as an LTE base station. The second cellular access point is implemented in accordance with a second radio access technology, such as NR, and is referred to below as an NR base station.

An action 202 comprises receiving information over a broadcast channel of the LTE base station. In certain embodiments, for example, the information might comprise an LTE Master Information Block (MIB) and one or more LTE System Information Blocks (SIBs). The MIB and SIBs contain information that is used by the communication device to attach to the LTE base station. Most relevant to this discussion, an SIB referred to as SIB2 may include an “upperLayerIndication” value indicating that the LTE base station supports Non-Standalone Architecture (NSA) Dual Connectivity in conjunction with the NR base station. The “upperLayerIndication” value may be referred to at times herein as a 5G availability indicator.

The 5G availability indicator, when set to “TRUE” or “ON”, indicates that 5G services are generally available in the geographic area within which the communication device is located. In many cases, this indication may indicate only that the LTE base station is associated with an NR base station and configured to support NSA Dual Connectivity in conjunction with the NR base station. The cellular communication device may take further actions, as described below, to determine whether NR communications are actually possible at any given time.

The action 202 might be performed, for example, when the communication device is turned on and scans LTE frequency bands to find a suitable LTE signal, or when the communication device is handed off to a new cell.

An action 204 comprises establishing communications with the LTE base station of a network cell. For example, the action 204 may comprise camping on or attaching to the LTE base station, based on information received in the MIB and Ms. As the communication device is moved about, it may camp on different LTE base stations of other network cells, after obtaining MIBs and Ms from those LTE base stations.

An action 206 comprises determining whether broadcast information from the LTE base station indicates that 5G services are available to the communication device and/or that 5G services are generally available in the geographic area within which the communication device is located. In some embodiments, the action 206 may comprise evaluating SIB2 to determine whether the 5G availability indicator “upperLayerIndication” is set to a positive, “TRUE”, or “ON” value. If the “upperLayerIndication” value is not set to a positive, “TRUE”, or “ON” value, an action 208 is performed of displaying an LTE symbol, or some symbol that does not indicate 5G availability.

If the information received from the LTE base station indicates that 5G services are available, an action 210 is performed. The action 210 comprises determining the RF frequencies used by the NR base station for communicating with cellular devices. In particular, the action 210 may comprise receiving, from the LTE base station, an identification of one or more frequencies used by the associated NR base station. For example, the action may comprise receiving RRC messages from the LTE base station, where the RRC messages indicate the one or more frequencies that are used by the associated NR base station. More specifically, this information can be obtained from the MeasObjectNR information element as specified in 3GPP TS 36.331, Version 15.2.2, Paragraph 6.3.5.

An action 212 performed in response to receiving a 5G availability indicator indicating that 5G services are available and determining the one or more frequencies being used by the NR base station. The action 212 comprises searching for one or more RF signals on these frequencies and measuring the RF signals. For example, the action 212 may comprise scanning the identified RF frequencies to detect RF signals, and measuring the signal strengths of one or more of the detected RF signals.

In some cases, RF signals transmitted by the NR base station on the identified frequencies may include broadcast signals that are coded to indicate System Frame Numbers (SFNs). In some embodiments, including embodiments in which the RF signals are coded to indicate SFNs, the measuring may be done without decoding the signals and without determining the SFNs, thereby reducing any overhead that would otherwise be incurred.

An action 214 comprises determining whether any of the RF signals satisfy one or more signal criteria. For example, the action 212 may comprise determining whether an RF signal on one of the identified frequencies is greater than a threshold, such as a specified minimum signal strength or Reference Signal Received Power (RSRP). Again, determining that the RF signal satisfies the one or more signal criteria may be performed without decoding the RF signals transmitted by the NR.

If at least one of the RF signals satisfies the one or more signal criteria, an action 216 is performed of displaying a 5G symbol on the cellular communication device, indicating that 5G/NR radio access technology is currently available to the cellular communication device. The 5G symbol can be any symbol that is known to be associated with 5G communications or that otherwise identifies the 5G network. For example, the symbol may comprise the text “5G”.

If none of the RF signals satisfy the one or more signal criteria, the action 208 is performed, comprising displaying the LTE identifier in the status bar or other display area of the communication device. The LTE identifier can be any symbol that is known to be associated with LTE communications or that otherwise identifies the LTE network. Alternatively, a symbol corresponding to any other type of available network, such as a 3G network, may be displayed.

The actions of FIG. 200 are repeated, starting at the action 206, to periodically update the displayed network symbol. For example, these actions may be repeated every several seconds, or in response to other conditions or events. When the cellular communication device moves to new cells and corresponding LTE base stations, the actions are repeated starting at the action 202.

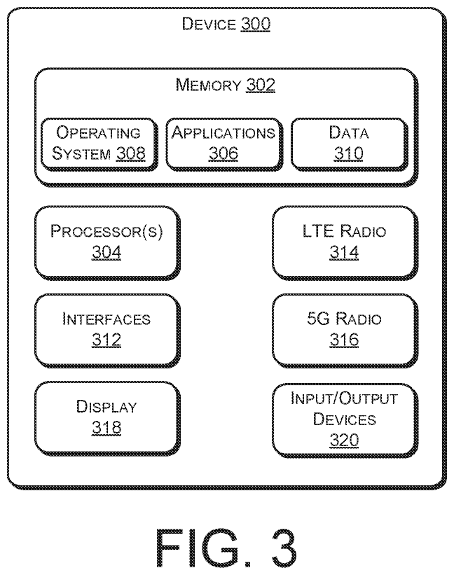

FIG. 3 illustrates an example cellular communication device 300 that may be used to implement the techniques described herein. The method 200 of FIG. 2, for example, may be implemented by a device such as the device 300.

The device 300 is an example of a communication device 110 as shown in FIG. 1. FIG. 3 shows only basic, high-level components of the device 300.

The device 300 may include memory 302 and a processor 304. The memory 302 may include both volatile memory and non-volatile memory. The memory 302 can also be described as non-transitory computer-readable media or machine-readable storage memory, and may include removable and non-removable media implemented in any method or technology for storage of information, such as computer executable instructions, data structures, program modules, or other data. Additionally, in some embodiments the memory 302 may include a SIM (subscriber identity module), which is a removable smart card used to identify a user of the device 300 to a service provider network.

The memory 302 may include, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other tangible, physical medium which can be used to store the desired information. The memory 302 may in some cases include storage media used to transfer or distribute instructions, applications, and/or data. In some cases, the memory 302 may include data storage that is accessed remotely, such as network-attached storage that the device 300 accesses over some type of data communication network.

The memory 302 stores one or more sets of computer-executable instructions (e.g., software) such as programs that embody operating logic for implementing and/or performing desired functionality of the device 300. The instructions may also reside at least partially within the processor 304 during execution thereof by the device 300. Generally, the instructions stored in the computer-readable storage media may include various applications 306 that are executed by the processor 304, an operating system (OS) 308 that is also executed by the processor 304, and data 310.

In some embodiments, the processor(s) 304 is a central processing unit (CPU), a graphics processing unit (GPU), both CPU and GPU, or other processing unit or component known in the art. Furthermore, the processor(s) 304 may include any number of processors and/or processing cores. The processor(s) 304 is configured to retrieve and execute instructions from the memory 302.

The device 300 may have interfaces 312, which may comprise any sort of interfaces known in the art. The interfaces 312 may include any one or more of an Ethernet interface, wireless local-area network (WLAN) interface, a near field interface, a DECT chipset, or an interface for an RJ-11 or RJ-45 port. A wireless LAN interface can include a Wi-Fi interface or a Wi-Max interface, or a Bluetooth interface that performs the function of transmitting and receiving wireless communications using, for example, the IEEE 802.11, 802.16 and/or 802.20 standards. The near field interface can include a Bluetooth® interface or radio frequency identifier (RFID) for transmitting and receiving near field radio communications via a near field antenna. For example, the near field interface may be used for functions, as is known in the art, such as communicating directly with nearby devices that are also, for instance, Bluetooth® or RFID enabled.

The device 300 may also have an LTE radio 314 and a 5G radio 316, which may be used as described above for implementing dual connectivity in conjunction with an eNodeB and a gNodeB. The radios 314 and 316 transmit and receive radio frequency communications via an antenna (not shown).

The device 300 may have a display 318, which may comprise a liquid crystal display or any other type of display commonly used in telemobile devices or other portable devices. For example, the display 318 may be a touch-sensitive display screen, which may also act as an input device or keypad, such as for providing a soft-key keyboard, navigation buttons, or the like.

The device 300 may have input and output devices 320. These devices may include any sort of output devices known in the art, such as a display (already described as display 318), speakers, a vibrating mechanism, or a tactile feedback mechanism. Output devices may also include ports for one or more peripheral devices, such as headphones, peripheral speakers, or a peripheral display. Input devices may include any sort of input devices known in the art. For example, the input devices may include a microphone, a keyboard/keypad, or a touch-sensitive display (such as the touch-sensitive display screen described above). A keyboard/keypad may be a push button numeric dialing pad (such as on a typical telemobile device), a multi-key keyboard (such as a conventional QWERTY keyboard), or one or more other types of keys or buttons, and may also include a joystick-like controller and/or designated navigation buttons, or the like.

Although features and/or methodological acts are described above, it is to be understood that the appended claims are not necessarily limited to those features or acts. Rather, the features and acts described above are disclosed as example forms of implementing the claims.

What is claimed is:

1. A method performed by a cellular communication device, comprising:
receiving, from a first base station, an indication that the first base station is associated with a second base station to support dual connectivity, wherein the first base station operates using a first radio access technology and the second base station operates using a second radio access technology;
in response to receiving the indication, measuring a radio frequency (RF) signal transmitted by the second base station;
determining, based at least in part on the measuring, that the RF signal satisfies one or more signal criteria; and
in response to determining that the RF signal satisfies the one or more signal criteria, displaying a symbol on the cellular communication device indicating that the second radio access technology is currently available to the cellular communication device.

2. The method of claim 1, wherein determining that the RF signal satisfies the one or more signal criteria is performed without decoding the RF signal.

3. The method of claim 1, wherein receiving the indication comprises receiving a System Information Block (SIB) from the first base station.

4. The method of claim 1, further comprising:
receiving, from the first base station, an identification of one or more frequencies used by the second base station for communications with cellular devices; and
searching for the RF signal on the one or more frequencies.

5. The method of claim 4, wherein receiving the identification comprises receiving a Radio Resource Control (RRC) message from the first base station.

6. The method of claim 1, wherein:
the first radio access technology is a 4^{th}-Generation (4G) radio technology; and
the second radio access technology is a 5^{th}-generation (5G) radio access technology.

7. The method of claim 1, wherein the one or more signal criteria comprise a minimum signal strength.

8. A cellular communication device, comprising:
one or more processors; and
one or more non-transitory computer-readable media storing computer-executable instructions that, when executed by the one or more processors, cause the one or more processors to perform actions comprising:
establishing communications with a master base station of a network cell, wherein the master base station operates using 4^{th}-Generation (4G) radio access technology;
receiving, from the master base station, a System Information Block (SIB) indicating that the master base station supports a Non-Standalone Architecture (NSA) of a 5^{th}-Generation (5G) communication network;
receiving, from the master base station, an identification of one or more frequencies used by a secondary base station that is associated with the master base station, wherein the secondary base station operates using 5^{th}-Generation radio access technology;
in response to receiving the SIB, measuring a radio frequency (RF) signal of at least one of the one or more frequencies used by the secondary base station;
determining, based at least in part on the measuring, that the RF signal satisfies one or more signal criteria; and
in response to determining that the RF signal satisfies the one or more signal criteria, displaying a symbol on the cellular communication device indicating that 5G services are currently available to the cellular communication device.

9. The cellular communication device of claim 8, the actions further comprising measuring strengths of multiple signals corresponding respectively to the one or more frequencies.

10. The cellular communication device of claim 8, wherein determining that the RF signal satisfies the one or more signal criteria is performed without decoding the RF signal.

11. The cellular communication device of claim 8, wherein:
the RF signal is coded to indicate System Frame Numbers (SFNs); and
determining that the RF signal satisfies the one or more signal criteria is performed without decoding the RF signal to obtain the SFNs.

12. The cellular communication device of claim 8, the actions further comprising scanning the one or more frequencies to detect the RF signal.

13. The cellular communication device of claim 8, wherein the one or more signal criteria comprise a minimum signal strength.

14. A method, comprising:
establishing communications with a master base station of a network cell, wherein the master base station operates using 4^{th}-Generation (4G) radio access technology;
receiving, from the master base station, an indication that the master base station is associated with a secondary base station to support a Non-Standalone Architecture (NSA) of a 5^{th}-Generation (5G) communication network, wherein secondary base station operates using 5G radio access technology;
receiving, from the master base station, an identification of one or more frequencies used by the secondary base station;
in response to receiving the indication, measuring a signal strength of a signal transmitted on the one or more frequencies by the secondary base station;
determining that the signal strength is greater than a threshold; and
in response to determining that the signal strength is greater than the threshold, displaying a symbol indicating 5G availability.

15. The method of claim 14, wherein determining that the signal strength is greater than the threshold is performed without decoding the signal.

16. The method of claim 14, wherein:
the signal is coded to indicate System Frame Numbers (SFNs); and
determining that the signal strength is greater than the threshold is performed without decoding the signal to obtain the SFNs.

17. The method of claim 14, further comprising searching for the signal on the one or more frequencies.

18. The method of claim 14, further comprising measuring strengths of multiple signals corresponding respectively to the one or more frequencies.

19. The method of claim 14, wherein receiving the identification comprises receiving a Radio Resource Control (RRC) message from the master base station.

20. The method of claim 14, wherein receiving the indication comprises receiving a System Information Block (SIB) that is broadcast from the master base station.
